(19) United States
(12) Patent Application Publication
(10) Pub. No.: US 2006/0101976 A1
(43) Pub. Date: May 18, 2006

(54) CIRCULAR CUTTING BLADE WITH DEPTH CONTROL SCALE

(76) Inventor: Ross M. Colquhoun, Seattle, WA (US)

Correspondence Address: IVAN E. ROZEK, 7023 123RD AVENUE SE, NEWCASTLE, WA, 98056-1215, US

(21) Appl. No.: 10/904,487

(22) Filed: Nov. 12, 2004

(51) Int. Cl. B23D 61/02

(52) U.S. Cl. 83/835

(57) ABSTRACT

A plurality of novel depth of cut scales are eccentrically inscribed on faces of circular cutting blades. The depth of cut marks on the scales are line segments that are easily lined up with the sole of a hand held circular saw, with the table of a table saw, or with the workpiece surface of a radial arm saw or a sliding miter saw. The accuracy of setting the depth of cut is greatly improved by the novel construct of the scales, which provides depth of cut index marks that are separated from each other by a distance larger than the difference between the indicated depths. The circular cutting blades with the novel depth of cut scales can be used in any cutting tool utilizing circular cutting blades without any modifications and without any additional external tools or instruments. The scales provided by present invention resolve to as small a distance as 1/32 of an inch on English units scales or to 0.5 mm on SI units scales. The resolution of scales so constructed increases as the diameter of the blade increases which is beneficial for table and radial arm saws using significantly larger blades than hand held saws.

### TECHNICAL FIELD

The invention relates to accurate setting of a desired depth of cut to be made by saws which employ circular saw blades for cutting. In particular it relates to setting cutting depths employing depth of cut scales inscribed on the saw blade that does not require additional tools, attachments, or fixtures to accurately and easily set the desired depth of cut.

### DESCRIPTION OF THE RELATED ART

Circular saw blades and dado blades are used to cut a work piece to a certain depth in many situations, such as making lap joints, dado joints, rabbet joints or any operation requiring forming a slot in the work piece. Also, setting a depth of cut is important when cutting overlain materials, such as plywood and siding over studs, or flooring and decking over joists or rafters.

At present, the extension of a blade through a sole plate of a hand held circular saw, or through a table of a table saw must be measured using an external tool to set the required depth of cut. The present state of the art requires the extension into the workpiece to be measured in the case of a sliding miter or a radial arm saw. The desired depth of cut is usually set by measuring the extension of a blade below the sole plate of a circular saw, above the table of a table saw, or the extension into the work piece of a radial arm or sliding miter saw, even though the saw can be modified with a permanently attached device as described hereinafter.

This process is cumbersome and inexact as, first the sliding blade guard must be withdrawn, next the perpendicular distance from the saw blade tip to the sole plate, or table or workpiece must be estimated, then the measurement must be made point to plate, table or workpiece, all the while balancing, in the case of a hand held circular saw, the saw and an external measuring tool while operating the adjustment lock and retracting the guard. Typically, once this is done a test cut is made, measured, and if necessary a further adjustment is made, repeating the process on until the desired degree of accuracy is achieved.

Many circular saws possess a depth control mechanism with a scale on the body of the saw. These scales are generally hard to read and rarely resolve smaller than 0.25 inches. Furthermore, these on-saw scales are restricted to a certain diameter of blade, so, for example a smaller diameter dado blade cannot benefit from an on-saw scale provided for the most often used 7.25″ saw blade. The use of the external accessories that are available for accurate depths of cut is time consuming when used with table and radial saws. The use of such external accessories is impractical or impossible to use when working with a portable circular saw at a site other than a shop. Additionally, in certain situations, such as roof construction, an attempt to use an external accessory may create a safety hazard.

Prior art, such as U.S. Pat. No. 4,904,130 by Gorman, teaches colored marks concentrically inscribed on a circular saw blade, wherein the smallest distance between the marks is 0.25 inches which is too large an increment for precision cutting. UK Patent Application GB 2,309,006 by Wrightman discloses concentric marks for depth adjustment, which are coded by line styles and the smallest distance between the marks is also 0.25 inches. US Patent Application Publication US 2004/0129125 A1 by Colquhoun discloses concentric marks for depth adjustment, which are also coded by line styles and wherein the smallest distance between the marks is 0.125 inches. The PCT Application, Publication No. WO 88/01557 by Richmond discloses a circular saw blade having four radial scales perpendicularly arranged with indices spaced at a regular interval of 0.0625 inches. The circular saw blade taught by Richmond is difficult to practice with good accuracy because the shape of the scales makes it difficult to adjust the cutting depth, as a single point at the cross-hairs must be aligned with the sole plate, or the table, and the rest of the line and the numerical index is obscured when used with hand held circular saws and table saws. Common for the prior art listed in this paragraph is a limitation arising from the fact that the sole plate of a hand held circular saw, or the surface of the cut material, contacts the scale index mark tangentially at one point only, further complicating the ability to set the depth of cut accurately and easily. Additionally, none of the prior art teaching the depth of cut scales on circular saw blades described in this paragraph has been available in stores or on the internet.

Prior art, such as U.S. Pat. No. 6,543,324 by Dils, discloses a more accurate depth of cut adjustment for cuts which are made perpendicular to the circular saw blade, requiring a device which is permanently attached to a specially modified table saw.

Prior art, such as U.S. Patent Application Publication US 2003/0024128 A1 and the PCT Application, Publication No. WO 002094516 by Balmelli, Dreher and Gairing, teach circular saw depth of cut adjustment means that are additions and modifications of hand saws.

### BRIEF SUMMARY OF THE INVENTION

The main object of the present invention is to provide an accurate and easy to use means for setting the depth of cut to be made into a workpiece by a rotary saw, such as a circular hand saw, a table saw, a sliding miter saw, or a radial arm saw. Another object of the present invention is to provide the depth of cut setting means without the need to resort to external tools. Yet another object of the invention is to provide a depth of cut setting means that can be used with cutting blades utilizing any cutting means, such as tipped or untipped cutting teeth, or other means of cutting as is encountered in diamond concrete or masonry saws, or with razor saw blades used in textile or medical processes. The objects of the invention are achieved by novel depth of cut scales inscribed on a face of a circular cutting blade. The depth of cut scales may be inscribed on either or both faces of the circular cutting blade. Blades so marked may be equally used in blade-left-of-the-drive and blade-right-of-the-drive saws. There may be a plurality of depth of cut scale inscribed on a circular cutting blade face, wherein the said plurality may comprise scales in English units, or in SI units which are also known as metric units, or the said plurality of depth of cut scales may include scales optimized for increased resolution, or the said plurality of depth of cut scale may include scales optimized for increased range.

Two types of novel scales are provided by the present invention. The first realization provides a scale, wherein the scale indices are inscribed along segments of a planar scale shape defining curve and wherein the planar shape defining curve is eccentrically located on a circular cutting blade face. The second realization provides a scale, wherein the scale indices are segments of secant lines of the imaginary circle defining the outer limits of the circular cutting blade, wherein the said secant lines intersect in a single point. The point where the said secant lines intersect may be eccentrically located on the cutting blade itself, or the point may be located outside of the cutting blade on the plane of the cutting blade face.

A unique characteristic of the novel scales provided by the present invention is the magnification of the depth of cut setting with respect to the actual cut, that is, the actual distance between scale indices on the cutting blade is larger than the difference of the depth to be cut to be made in a workpiece indicated by the corresponding indices. Indices so arranged therefore provide for increased accuracy of the depth setting, resolving to a so far unachievable 0.03125 inches distance between indices.

Another unique characteristic of the novel scales provided by the present invention is the universality, wherein the circular cutting blades with the depth of cut scales are usable in most rotary saws without having to resort to additional devices or to saw modifications. Yet another unique characteristic of the novel scales provided by the present invention are the index marks, wherein the index marks are clearly marked line segments so arranged that the saw operator needs only line up the sole plate of a hand held circular saw, the table of a table saw, or the workpiece surface of a radial or sliding miter saw, with the corresponding index mark.

### BRIEF DESCRIPTION OF THE DRAWINGS

FIG. 1 is a side view of a circular cutting blade depicting an English units scale and a SI units scale of the present invention embodiment, wherein the scale shape defining curve is a circular segment of approximately the same diameter as the diameter of the circular cutting blade.

FIG. 2 is a side view of a circular cutting blade depicting the construction of a scale along a shape defining curve.

FIG. 3 is a side view of a circular cutting blade illustrating the effect of the parameters of the shape defining curve on the characteristics of the depth of cut scale.

FIG. 4 is a side view of a circular cutting blade depicting the construction of a scale, wherein the scale indices are segments of secant lines intersecting in a single point on a circumference of the cutting blade. Only a part of the blade is shown to preserve clarity of the scale construction.

FIG. 5 is a side view of a circular cutting blade depicting the construction of a two-scale embodiment, wherein there is a scale indices of which are segments of secant lines intersecting in a single point on the circumference of the cutting blade, and wherein there are additional scale indices, which are segments of secant lines intersecting in a single point within the circumference of the cutting blade. Only a part of the blade is shown to preserve clarity of the scale construction.

FIG. 5a is a side view of a circular cutting blade depicting the relationship between the location of the point at which the secant lines intersect and the separation of the index marks.

FIG. 6 is a side view of a circular cutting blade depicting an English units scale and a SI units scale of the present invention embodiment, wherein the secant lines from which the indices of both scales are formed intersect in one point on the circumference of the circular cutting blade.

FIG. 7 is a side view of a circular cutting blade depicting an English units scale and a SI units scale of the present invention embodiment, wherein the secant lines from which the indices of the English units scales are formed intersect in one point on the circumference of the circular cutting blade, and wherein the secant lines from which indices of the SI units scales are formed intersect in a separate point on the circumference of the circular cutting blade.

FIG. 8 is a schematic of a handheld circular saw illustrating the adjustment of the depth of cut on a hand saw with the present invention.

### DETAILED DESCRIPTION OF PREFERRED EMBODIMENTS

Scales inscribed on either or both faces of circular cutting blades or dado blades are provided by the present invention for setting a circular saw to groove, or to cut into, a workpiece to a limited depth.

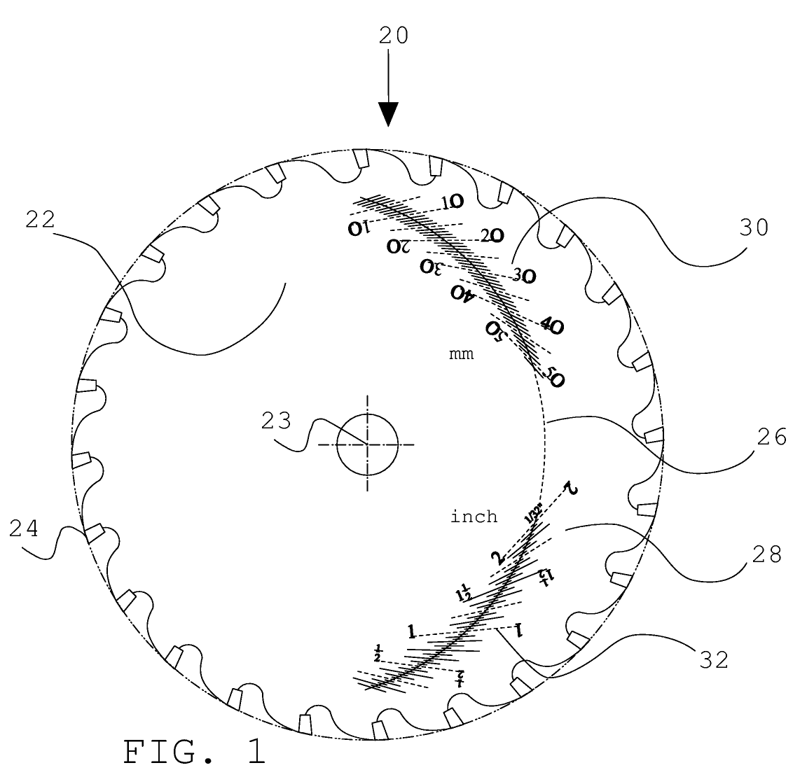

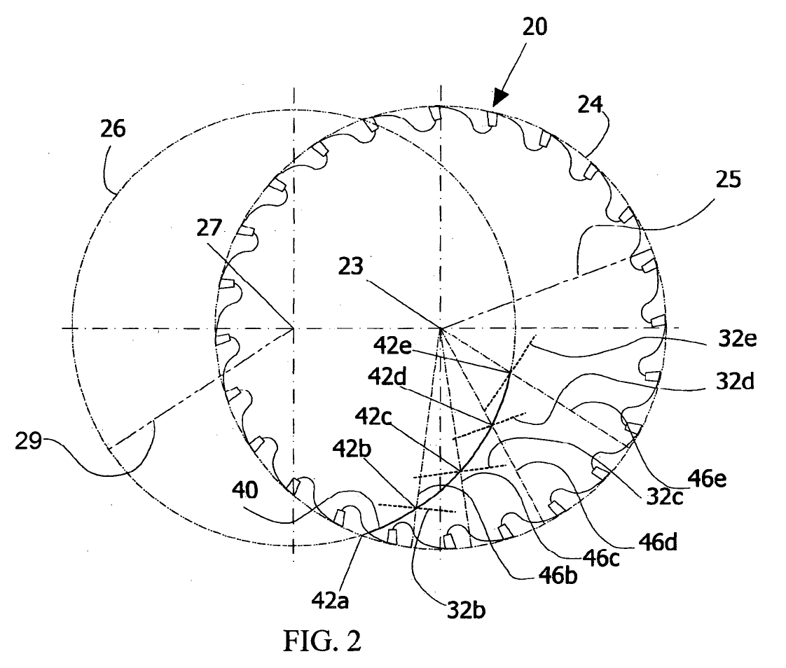

FIG. 1 shows a circular cutting blade 20 comprising a face 22 which extends from a center of the circular cutting blade 23 to a periphery bearing a cutting edge 24. An English units scale in inches 28 and a SI units scale in millimeters 30 are formed along a scale shape defining curve 26. The index marks 32 are bisected by the scale shape defining curve 26, wherein the angle formed by the index marks 32 and the scale shape defining curve 26 is different for each mark, to be explained with reference to FIG. 2 hereinafter. The line type and segment length of the index marks 32 are grouped by the scale unit increments to differentiate among the scale unit increments to enhance the ease of use. Numerals are inscribed on the cutting blade faces next to the indices defining a major scale unit increment. One-half inch depth adjustment increments are numerically shown on the English scale, and 10 mm depth adjustment increments are shown on the SI scale shown on FIG. 1. The inch scale of the preferred embodiment depicted on FIG. 1 has marks spaced in 0.03125″ increments and the SI scale of the preferred embodiment depicted on FIG. 1 has marks spaced in 1.0 mm increments. The magnification of scales provided by the present invention allows for 0.5 mm increments to be inscribed on the SI scale, not shown on FIG. 1 for clarity. The index marks corresponding to the standard U.S. lumber and plywood thickness can be adjusted with a contrasting color.

The construction of a depth of cut scale along a shape defining curve is depicted on FIG. 2. A circle 26 having a radius 28 of approximately the same length as the radius 25 of the circular cutting blade 20 is selected to be the scale shape defining curve for the preferred embodiment. The distance between the center 27 of the circle 26 and the center 23 of the circular cutting blade 20 is approximately 70% of the radius 25. A first end 42a of the segment 40, which corresponds to zero depth of cut by the circular cutting blade 26, is defined by the intersection of the circle 26 with the periphery 24 of the circular cutting blade 20; A second end 42e of the segment 40 is defined by a point corresponding to the largest indicated depth of cut to be shown on the circular cutting blade 20, wherein the largest indicated depth of the preferred embodiment is approximately 55% of the radius 25; Equally spaced points: 42b, 42c, and 42d, are defined on the segment 40 between the first end 42a and the second end 42e of the segment 40, wherein the number of points is equal to the number of index marks 32 shown on the depth of cut scale. It should be pointed out that only four index marks are shown on FIG. 2 to preserve the clarity of description of the preferred embodiment.

The indices 32, of which the index marks 32b, 32c, 32d and 32e are shown, are bisected by the scale shape defining curve and are perpendicular to the corresponding invisible radial line 46, of which the lines 46b, 46c, 46d and 46e are shown, extending from the center 23 of the circular cutting blade 20 through the corresponding intersection of the index mark 32 with the scale shape defining curve segment 40.

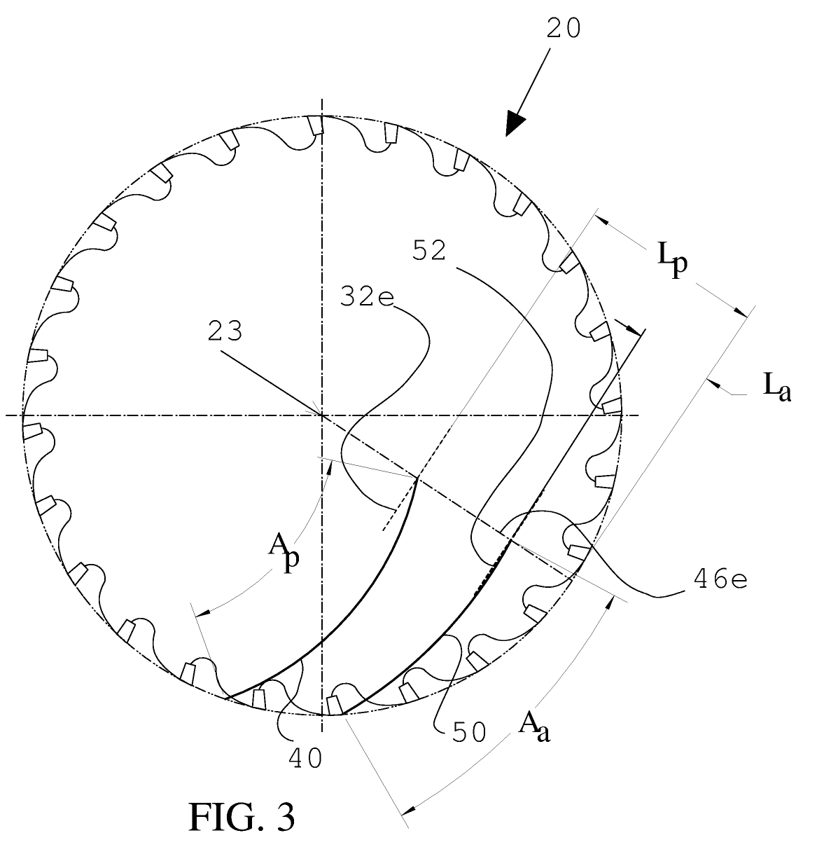

An innumerable number of embodiments can be created by varying the type of the scale shape defining curve. The scale shape defining curve types can comprise a line segment, a chord, a circular arc, a segment of a hyperbola, a spline or a Bezier curve through a set of points. The scale shape defining curve based scales can be optimized for increased accuracy or they can be optimized for enlarged span of the scale. The effect of the parameters of the shape defining curve on the scale characteristics is illustrated on FIG. 3, wherein the circular cutting blade 20 is shown with the scale shape defining curve segment 40 extending from the periphery of the cutting blade 20 to the index mark 32e, and with an alternate scale shape defining curve segment 50 extending from the periphery of the cutting blade 20 to the index mark 52. The invisible radial line 46e extends from the cutting blade center 23 through the intersection of the segment 40 with the index mark 32e and through the intersection of the segment 50 with the index mark 52. The depth of cut defined by the index mark 32e is equal to Lₚ. The length of path along the segment 40 is equal to Aₚ. The ratio Lₚ/Aₚ is approximately equal to 1.7, providing a gain in accuracy of 70% compared to concentric scales. This explains why the distance between index marks of the scales using eccentric shape defining curves is greater than the distance between the corresponding index marks of concentric scales. This also explains why the scales utilizing the scale shape defining curves can resolve to a so far unachievable 0.03125 inches. Furthermore, the alternate embodiment as defined by the segment 50, provides a depth of cut equal to Lₐ and the length of path along the segment 50 is equal to Aₐ. The ratio Lₐ/Aₐ as shown in FIG. 3 is approximately equal to 3.2, providing an effective gain in accuracy of 320% compared to concentric scales. Consequently, the largest depth setting Lₐ is equal approximately to 40% of the largest depth setting Lₚ illustrating how a selection of the scale shape defining curve can be used to optimize the scales for a specific purpose.

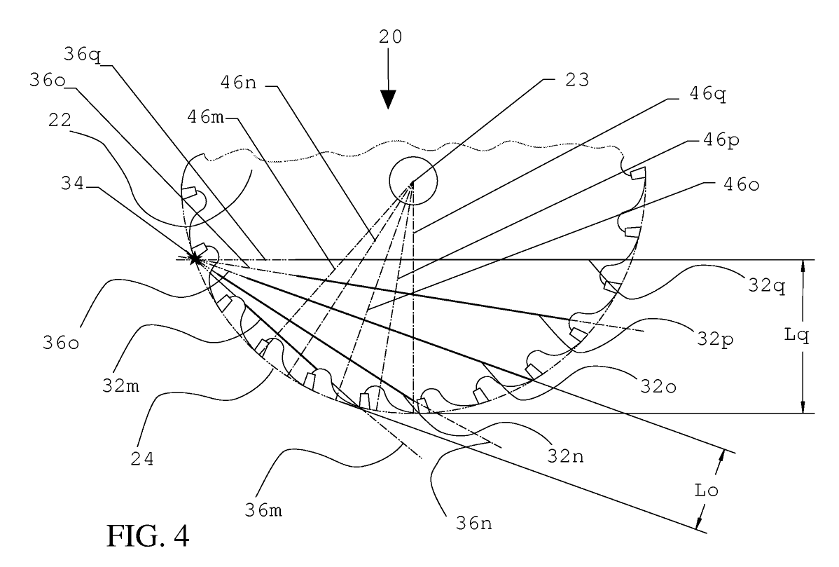

Another preferred embodiment of the depth of cut scale inscribed on a face of a circular cutting blade is depicted on FIG. 4. The scale is formed from secant lines 36 located on the face 22 that intersect in a single point 34, wherein the intersection point 34 is located on the periphery 24 of the circular cutting blade 20 in the illustrated embodiment. The depth of cut defined by a particular index mark 32 is the perpendicular distance from an index mark 32 to the cutting edge 24, along the corresponding radial line 46 that is perpendicular to the secant line 36, segment of which is the mark 32.

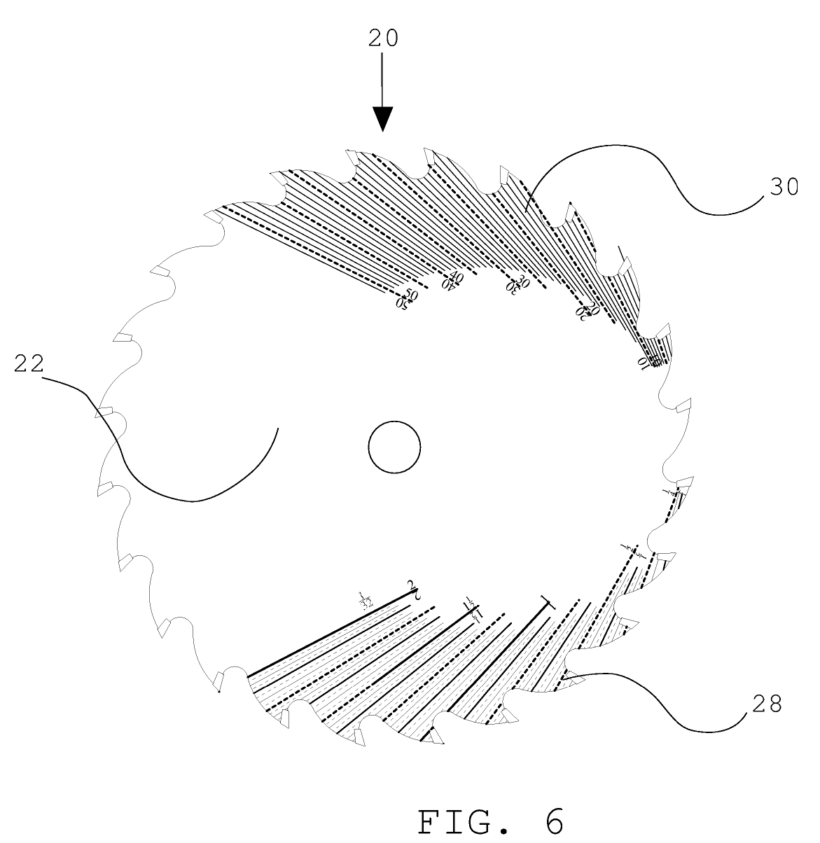

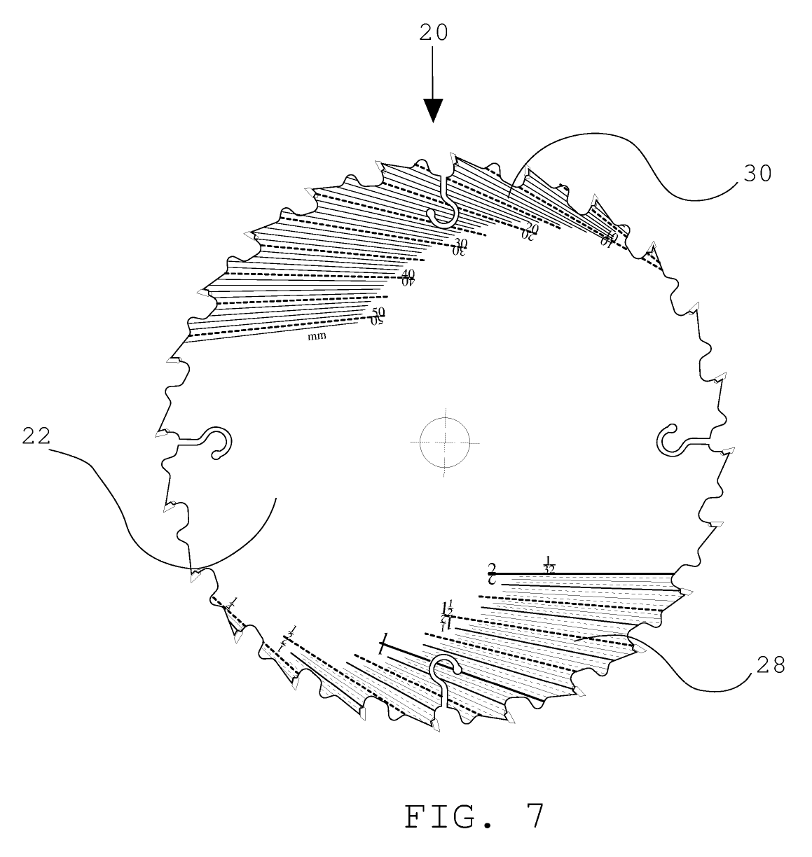

The secant lines 36, and the radial lines 46 corresponding to index marks 32, and the intersection point 34, are shown only to describe the invention. Only the indices 32 are inscribed on the circular cutting blade face as shown hereinafter on FIG. 6 and on FIG. 7 depicting two of the many possible embodiments of the present invention that can be formed from secant lines intersecting in a single eccentrically located intersection point.

The relationship between the depth of the cut indicated by the indices 32 and the distance between the corresponding index marks is demonstrated on index marks 32o and 32q. The depth of cut indicated by the index mark 32o is the length Lo along the radial line 46o which is perpendicular to the secant line 36o. The depth of cut indicated by the index mark 32q is the length Lq along the radial line 46q which is perpendicular to the secant line 36q. The same relationship exists among the index marks 32m, 32n, and 32p with the secant lines 36m, 36n, and 36p and with the radial lines 46m, 46n, and 46p. The lengths Lm, Ln, and Lp are not shown to preserve clarity.

The advantage provided by these scales can be appreciated when a difference between the distance indicated by two depth indicators is compared to the distance between the same two depth indicators at the distal end from the common intersection 34, wherein the distance at the distal end is significantly larger. For example, the difference between the depth of cut illustrated by lengths Lq and Lo is one inch, yet the distance between the index marks 32q and 32o at the distal end is two inches, providing an effective gain of 100% in accuracy.

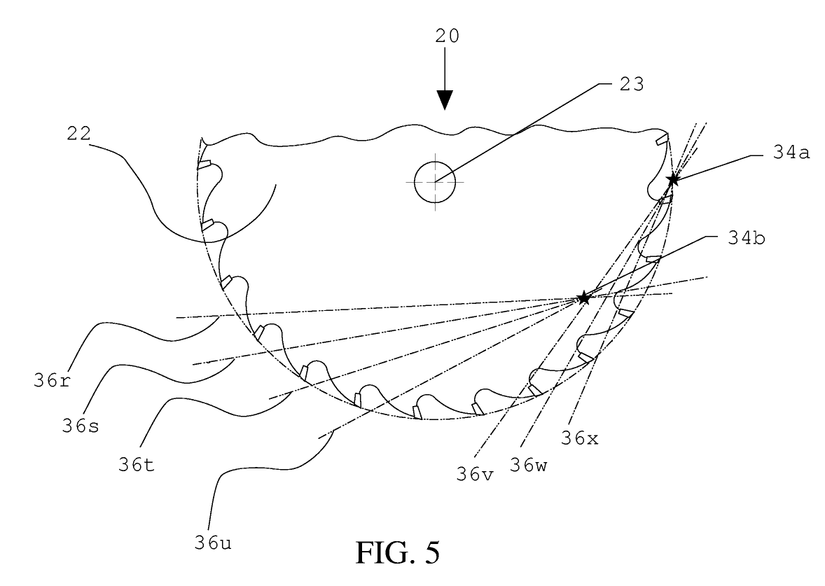

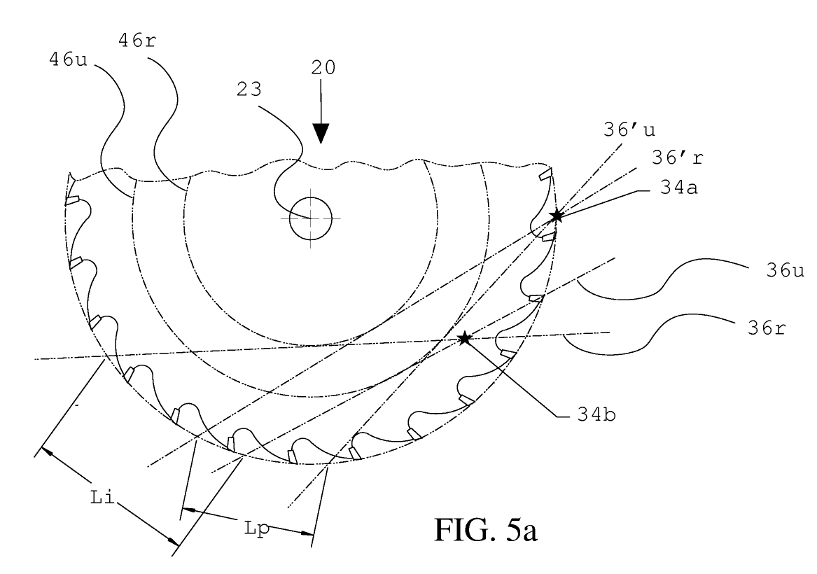

This gain in the distance between index marks formed from secant lines 36 is further increased by locating the secant line 36 intersect point 34 closer to the center 23 on the face 22 of the circular cutting blade 20 as illustrated by the point 34b on FIG. 5a. Secant lines 36r, and 36s, and 36t, and 36u intersect in point 34b, while secant lines 36x, and 36v, and 36w intersect in point 34a located on the periphery of the circular cutting blade 20. The secant lines 36v, and 36w, and 36x are provided for creating depth setting index marks, wherein the depths indicated by the index marks created from the secant lines 36v, 36w and 36x are smaller than the radial distance between the periphery of the circular cutting blade 20 and the index mark 34b.

The relationship between the distance between the index marks created from secant lines 36 and the location of the intersection point 34 is illustrated on FIG. 5a: Secant lines 36r and 36u shown intersecting in point 34b on FIG. 5, are reconstructed as secant lines 36′r and 36′u intersecting in point 34a, which is located on the periphery of the circular cutting blade 20, wherein the secant lines 36′r and 36′u are located at the same radial distance 46r and 46u from the circular cutting blade center 23 as the corresponding secant lines 36r and 36u. In the example illustrated on FIG. 5a, the ratio of chordal lengths Li to Lp, provides an additional 25% gain in accuracy by moving the intersecting point closer to the center 23 of the circular cutting blade 20.

Illustrated on FIG. 6 is the embodiment comprising an English units scale 28 and a SI units scale 30, both inscribed on the face 22 of the circular cutting blade 20, wherein the index marks of both scales were created from secant lines intersecting in one point on the periphery of the circular cutting blade 20 with the techniques described in the preceding paragraphs and illustrated on FIG. 4, FIG. 5 and FIG. 5a.

Illustrated on FIG. 7 is the embodiment comprising an English units scale 28 and a SI units scale 30, both inscribed on the face 22 of the circular cutting blade 20, wherein the index marks of each scale were created from secant lines intersecting in one point on the periphery of the circular cutting blade 20, and wherein there are two intersect points, one for each scale.

The line type and segment length of the index marks are grouped by the scale unit increments to differentiate among the scale unit increments to enhance the ease of use. The index marks corresponding to standard lumber and plywood thicknesses are shown with a contrasting color. Numerals are inscribed on the cutting blade faces next to the indices defining a major scale unit increment. The numerals are inscribed in a right-side-up and in an upside-down fashion with respect to the index mark they refer to, making the numerals visible and correctly readable regardless of the type of saw used.

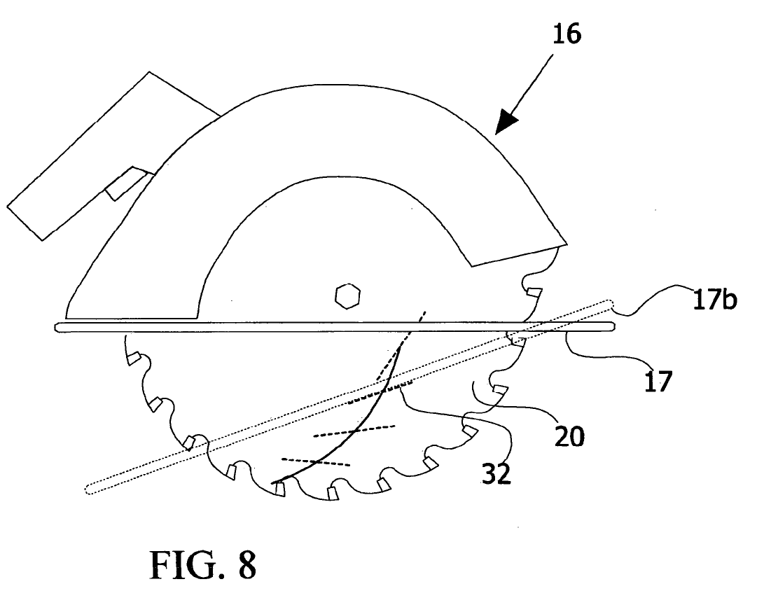

A schematic illustration of setting the depth of cut with a circular hand saw 16 comprising a circular cutting blade 20 with the depth of cut indicating scale and a sole plate 17 for adjusting the depth of cut is depicted on FIG. 8. To set the desired depth of cut, all the saw operator need do is rotate the desired depth of cut index mark 32 into alignment with the sole plate 17 as shown by the position 17b in FIG. 8. This simple setting of the depth of cut should be compared with the common practice of setting the depth of cut using a tape measure, or other external devices, to set the position of the sole plate 17. It should be pointed out that only four of the index marks 32 are shown on FIG. 8 to preserve the clarity of description of the preferred embodiment.

The index marks 32 are aligned with the cut material when used in radial and sliding miter saws to set the depth of cut. The index marks 32 are aligned with the table face when used in a table saw to set the depth of cut. It should also be pointed out that the simple alignment of the sole plate or of the workpiece with the index marks 32 is possible only if the index marks are perpendicular to the corresponding invisible radial lines 46 intersecting the corresponding index marks 32.

Because the index marks provided by the present invention are line segments along the alignment line of the cut material or along the sole plate, the depth setting is further enhanced in comparison to a single point depth setting means provided by prior art.

The face of the cutting tools shown can be inscribed in any desired manner. For example, the face can be etched, either mechanically, or chemically, or the face can be inscribed using an electrochemical process. Alternatively, laser marking can be used, with or without chemicals that change the color of the marks formed by the laser (if the color is changed, this can improve contrast and legibility).

As another alternative, a painted tool can be used with laser marking which burns the paint off, leaving remaining paint and burnished metal color to form contrasting markings.

Alternative methods of marking the circular cutting blades also include the use of decals (which however may come off in use), water jets, silkscreen printing processes, stencil marking, letterpress printing, pad printing (using epoxy ink), jet printers using ink or other appropriate liquids, dot peening to form a series of dots in the surface, or actual perforations in the surface.

1. A disk shaped circular cutting blade, comprising:
a center;
a circumference;
a pair of opposite faces, each radially extending from the center to the circumference;
cutting means disposed along the circumference; and
at least one depth of cut scale on one of the faces.

2. The circular cutting blade of claim 1, wherein the depth of cut scale comprises:
a plurality of index marks, wherein each index mark is located perpendicularly to a corresponding non-visible circular cutting blade radius line, and intersects the corresponding radius line on a non-visible scale shape defining curve that bisects each of the index marks;
numeric descriptors located next to selected index marks, wherein each numeric descriptor indicates the radial distance from the circumference of the non-visible circular cutting blade to the intersection of the non-visible scale shape defining curve with the index marks next to which the numeric descriptor is located, wherein each numeric descriptor consists of a first and of a second numeral, wherein the second numeral is a rotated image of the first numeral and wherein the second numeral is located next to the same index mark as the first numeral;
and an alpha-numeric definition of distance units located near the depth of cut scale.

3. The circular cutting blade of claim 2, wherein the scale shape defining curve is an arc of a circle inscribed on the circular cutting blade face, wherein the center of the arc is offset from the center of the circular cutting blade, and wherein the radius of the arc is approximately equal to the radius of the circular cutting blade.

4. The circular cutting blade of claim 3, wherein the radial distance from each of the plurality of the index marks represents the depth of penetration of the disk shaped circular cutting blade into a workpiece in inches of the English system of units.

5. The circular cutting blade of claim 3, wherein the radial distance from each of the plurality of the index marks represents the depth of penetration of the disk shaped circular cutting blade into a workpiece in millimeters of the SI system of units.

6. The circular cutting blade of claim 2, wherein the scale shape defining curve is a segment of any analytical curve, the analytical curve having:
a first end which is the intersection of the analytical curve with the periphery of the circular cutting blade; and
a second end which is the point furthest distance radially away from the periphery of the circular cutting blade and wherein the distance from the first end of the segment to a point on the segment is greater than the radial distance from the periphery of the circular cutting blade to the said point on the segment.

7. The circular cutting blade of claim 6, wherein the radial distance from each of the plurality of the index marks represents the depth of penetration of the disk shaped circular cutting blade into a workpiece in inches of the English system of units.

8. The circular cutting blade of claim 6, wherein the radial distance from each of the plurality of the index marks represents the depth of penetration of the disk shaped circular cutting blade into a workpiece in millimeters of the SI system of units.

9. The circular cutting blade of claim 1, wherein the depth of cut scale comprises:
a plurality of index marks, wherein each index mark is a line segment, wherein each line segment is a segment of a secant line of the circular cutting blade circumference, and wherein all the secant lines from which the index marks are formed intersect in a single point preferably located on the circular cutting blade, and wherein the secant lines from which the index marks are formed are angularly equally separated from each other;
numeric descriptors located next to selected index marks, wherein each numeric descriptor indicates the radial distance from the circumference of the circular cutting blade to the intersection of the scale shape defining curve with the index marks next to which the numeric descriptor is located, wherein each numeric descriptor consists of a first and of a second numeral, wherein the second numeral is a rotated image of the first numeral and wherein the second numeral is located next to the same index mark as the first numeral; and
an alpha-numeric definition of distance units located near the depth of cut scale.

10. The circular cutting blade of claim 9, wherein the radial distance from each of the plurality of the index marks represents the depth of penetration of the disk shaped circular cutting blade into a workpiece in inches of the English system of units.

11. The circular cutting blade of claim 9, wherein the radial distance from each of the plurality of the index marks represents the depth of penetration of the disk shaped circular cutting blade into a workpiece in millimeters of the SI system of units.

12. A disk shaped circular cutting blade, comprising:
a pair of opposing circular cutting blade faces extending from a center to a common circumference having a cutting edge; and
a plurality of depth of cut index marks inscribed on one of the circular cutting blade faces, each of the index marks residing on a common curve.

13. The circular cutting blade of claim 12, wherein each index mark is bisected by the common curve and is located perpendicularly to a radius of the circular cutting blade.

14. The circular cutting blade of claim 13, wherein the common curve further comprises an arc of a circle inscribed on the circular cutting blade face, a center of the circle being offset from the center of the circular cutting blade face.

15. The circular cutting blade of claim 14, wherein the arc further comprises a radius that is approximately equal to the radius of the circular cutting blade.

16. A disk shaped circular cutting blade, comprising:
a cutting blade having a pair of opposing circular cutting blade faces extending from a common center to a common a cutting edge at a common circumference thereof; and
a plurality of depth of cut index marks inscribed on one of the circular cutting blade faces, each of the index marks residing on a single circle having a radius that is substantially the same as a radius of the cutting blade faces between the center and the common circumference.

17. The circular cutting blade of claim 16, wherein the common curve further comprises a circle having a radius that is substantially the same as a radius of the cutting blade faces between the center and the common circumference; and
wherein each of the plurality of depth of cut index marks further comprises a segment of a secant line of the circular cutting blade circumference.

18. The circular cutting blade of claim 17, wherein the secant lines forming each of the index marks intersect.

19. The circular cutting blade of claim 18, wherein an intersection of the secant lines is located substantially on a periphery of one of the circular cutting blade faces.

20. The circular cutting blade of claim 17, wherein an intersection of a first portion the secant lines is located substantially on a periphery of the cutting blade face, and an intersection of a second portion the secant lines is located on the cutting blade face between the center and the periphery of the cutting blade face.
